(19) United States
(12) Patent Application Publication
(10) Pub. No.: US 2005/0157450 A1
(43) Pub. Date: Jul. 21, 2005

(54) Battery housing module and method of assembling the same

(76) Inventors: Fang-Yu Liao, Sinjhuang City (TW); Jih-Yung Lu, Sanchong City (TW)

Correspondence Address: RABIN & Berdo, PC, 1101 14TH STREET, NW, SUITE 500, WASHINGTON, DC, 20005, US

(21) Appl. No.: 11/038,171

(22) Filed: Jan. 21, 2005

(30) Foreign Application Priority Data
Jan. 20, 2004 (TW) 93101683

(51) Int. Cl. F21L 4/00

(52) U.S. Cl. 361/620

(57) ABSTRACT

A battery housing module having a housing and a battery spring is provided. A slot having a groove is formed on the sidewall of the housing. The battery spring comprises an elastic portion for contacting one end of a battery, wherein the width of the elastic portion of the battery spring is smaller than the width of the groove. A contact portion electrically connects a printed circuit board assembled with the housing. A connection portion connects the elastic portion and the contact portion, wherein the width of the connection portion of the battery spring is larger than the width of the groove. During assembling, the elastic portion passes through the groove of the slot, the connection portion is inserted into the slot and is restricted by the groove, and the connection portion, which slides in the slot until, contacts an upper surface of the slot when reaching the contact portion.

This application claims the benefit of Taiwan application Serial No. 93101683, filed Jan. 20, 2004, the subject matter of which is incorporated herein by reference.

### BACKGROUND OF THE INVENTION

1. Field of the Invention

The invention relates in general to a battery housing module and the assembling method thereof, and more particularly to a mechanism and method enabling an easy assembly of the battery housing module of the battery spring and the housing so that assembly cost is reduced.

2. Description of the Related Art

There are several methods for the battery spring to be fixed onto the battery housing. The most commonly used methods are as follows: The battery spring, having been assembled with the battery housing, passes through a hole on the printed circuit board (PCB) to be soldered onto a pad disposed on the printed circuit board via tin soldering, so that the battery spring is fixed, meanwhile, a path is formed between the battery spring and the printed circuit board. Alternatively, a hot melting point is formed on the housing of the battery housing, and then the battery spring is directly hot melted on the housing. Another conventional method is to make a hole on the housing and the battery spring and screwed the two elements up after assembly to fix the battery spring on the housing.

Take digital still camera (DSC), one of the most popular electronic devices, for example. Apart from the features of slimness, compactness, light weight and small size, the durability is also a focus. Particularly, a digital camera changes the battery quite often. If the battery spring and the housing are assembled and fixed according to above conventional methods of tin soldering, hot melting or screwing, tin breaking or housing brokerage are very likely to occur after a period of usage. Besides, it is very time-consuming and labor-consuming to prepare tools for holing, screwing, tin soldering, or hot melting, not only increasing assembly cost but also increasing manufacturing costs.

### SUMMARY OF THE INVENTION

It is therefore an object of the invention to provide a battery housing module and the assembling method thereof. With the integration of a special shaped battery spring and a battery housing, the battery spring can be easily and firmly fixed onto the battery housing.

The invention achieves the above-identified object by providing a battery housing module, comprises a housing and a battery spring. The housing is for accommodating at least a battery, and a sidewall of the housing at least has a slot with a groove disposed thereon. The battery spring comprises an elastic portion for elastically contacting one end of the battery, while the width of the elastic portion is smaller than the width of the groove to allow the elastic portion to pass through the groove. One end of the connection portion is connected with the elastic portion, while the width of the connection portion is larger than the width of the groove so that the connection portion is restricted by the groove. The contact portion, connected with another end of the connection portion, extends over the upper surface of the sidewall and electrically connects a printed circuit board (PCB) disposed above.

During assembling, let the elastic portion of the battery spring pass through the groove of the slot, the connection portion is disposed in the slot and is restricted by the groove. Then, let the connection portion slide in the slot until the contact portion contacts an upper surface of the slot.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a side view of a battery spring according to a preferred embodiment of the invention;

FIG. 1B is a perspective diagram of a battery housing according to a preferred embodiment of the invention;

FIG. 1C is a side view of the slot in FIG. 1B;

FIG. 1D is a side view showing a battery is accommodated in an assembled battery housing;

FIG. 1E is a partial enlargement of a top view of the slot in FIG. 1B;

FIG. 2 is a perspective diagram of the assembly of a battery housing module according to a preferred embodiment of the invention;

FIG. 3 is a perspective diagram showing a battery spring fixed onto a battery housing in FIG. 2 after assembly; and

FIG. 4 is a sectional view of FIG. 2 after assembly.

### DETAILED DESCRIPTION OF THE INVENTION

The invention is designed to have a battery housing module, and use a special shaped battery spring to be assembled with the battery housing and fix the battery spring on the battery housing firmly and easily without resorting to conventional method of tin soldering, screwing or hot melting, etc. Despite the invention is exemplified by a preferred embodiment, the scope of protection of the invention is not limited thereto.

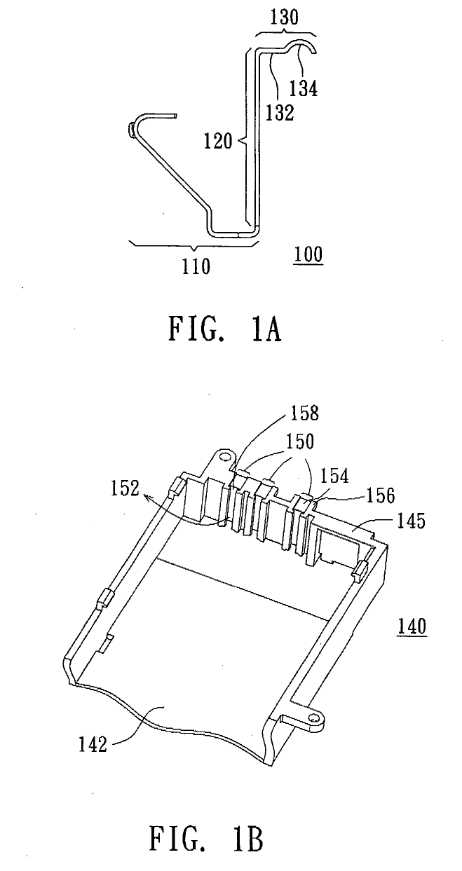

FIG. 1A is a side view of a battery spring according to a preferred embodiment of the invention. The battery spring 100, made of a conductive and elastic material, comprises an elastic portion 110 at the front end, a connection portion 120 at the middle part and a contact portion 130 at the rear end. The front end elastic portion 110 is for elastically contacting one end of a battery. The connection portion 120 is connected with the elastic portion 110 and the contact portion 130. The contact portion 130 extends over the upper surface of the sidewall 145 and electrically contacts a printed circuit board (PCB) (shown in FIG. 1D, labeled 200). Besides, the contact portion 130 preferably comprises a flat portion 132 and an arced portion 134 to assure that the arced portion 134 still contacts the printed circuit board after assembly.

FIG. 1B is a perspective diagram of a battery housing according to a preferred embodiment of the invention. The battery housing 140 has a moveable battery capping 142 for accommodating at least a battery (shown in FIG. 1D, labeled 250) to provide a power source to an electronic device such as a digital still camera (DSC). At least one slot 150 is formed on a sidewall 145 of the battery housing 140 for assembling the battery spring 100. The diagrams and drawings in the present preferred embodiment are exemplified by three slots 150 and the three corresponding battery springs 100, however the invention is not limited thereto. The slot 150 has a groove 152 facing the internal of the battery housing 140, and the rear end of the slot 150 has a rear-end aperture 158.

Referring to FIG. 1C, a side view of the slot in FIG. 1B is shown. Preferably, the upper surface of the slot 150 comprises a first plane 154 and a second plane 156, wherein the first plane 154 is slightly lower than the second plane 156 for accommodating a flat portion 132 of the battery spring 100.

Referring to FIG. 1E, a partial enlargement of a top view of the slot 150 in FIG. 1B is shown. The width W2 of the groove 152 is smaller than the width W1 of the inner wall of the slot 150.

Referring to FIG. 1D, a side view showing a battery is accommodated in an assembled battery housing is shown. After the battery spring 100, the battery housing 140 and the printed circuit board 200 in FIG. 1A are assembled, a space for accommodating a battery 250 is formed. When the battery 250 is accommodated within, one end of 252 of the battery 250 can have a plurality of connection points for elastically contacting a plurality of battery spring 100 respectively and become electrically connected respectively. Another end of the battery 250, which correspondingly abuts a spring 142 disposed in the housing 140, can selectively become electrically connected.

It can be seen from FIGS. 1A˜1E, the connection portion 120 of the battery spring 100 is disposed in the slot 150, while the flat portion 132 projects from a rear-end aperture 158 to be disposed on the first plane 154, the projected arced portion 134 abuts the printed circuit board 200.

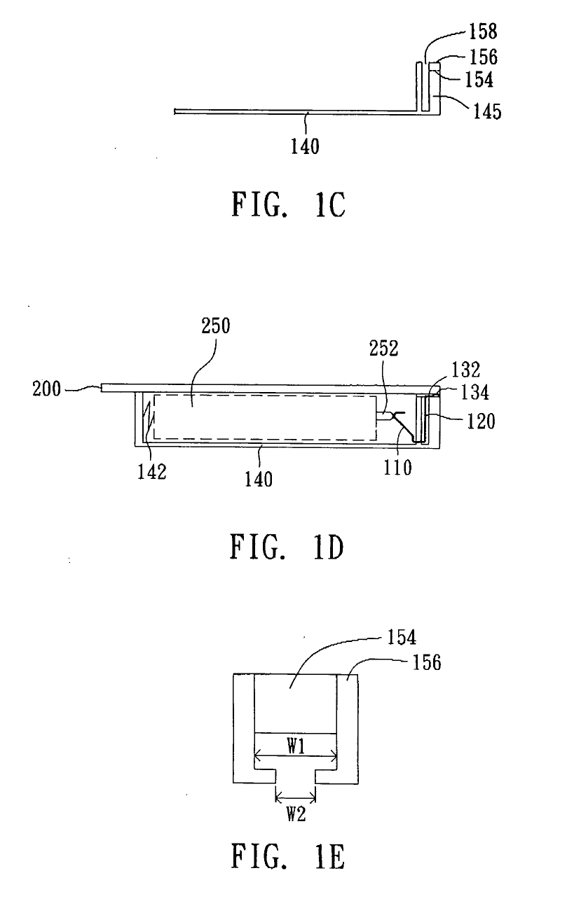

FIG. 2 is a perspective diagram of the assembly of a battery housing module according to a preferred embodiment of the invention. The shape of the battery spring 100 can be seen in FIG. 2. Referring to FIG. 1A, it is noteworthy that the width of the elastic portion 110 of the battery spring 100 is smaller than the width of the connection portion 120, and the width of the elastic portion 110 at least is smaller than the width W2 of the groove 152 so that the elastic portion 110 can pass through the groove 152 and extend toward the battery. The width of the connection portion 120 is larger than the width W2 of the groove 152 so that the connection portion 120 is restricted by the groove 152. For example, if the groove 152 is 5 mm, then the elastic portion 110 and the connection portion 120 are respectively equal to 3 mm and 7 mm.

During assembling, let the elastic portion 100 of the battery spring 100 passes through its corresponding groove 152 of the slot 150 while the connection portion 120 is restricted in its corresponding groove 152. Press the connection portion 120 downward to slide in the slot 150 until the contact portion 130 contacts the upper surface of the slot 150. Lastly, assemble the printed circuit board 200 and the battery housing 140.

In the present preferred embodiment, the rear end of the contact portion 130 of the battery spring 100 is designed to have a lumped arced portion 134, which is pressed downward by the printed circuit board 200 and becomes slightly deformed when the printed circuit board 200 and the battery housing 140 are assembled, can tightly contact its corresponding pad 260 disposed on the printed circuit board 200 to assure that the battery spring 100 and the printed circuit board 200 firmly are electrically connected.

Besides, in practical application, the printed circuit board 200 disposed on the housing 140 can be used to directly press the connection portion 120 downward, so that the connection portion 120 slides until the flat portion 132 of the battery spring 100 contacts the first plane 154 of the slot 150. The printed circuit board 200 can be assembled with the battery housing 140 via a hook or a screw.

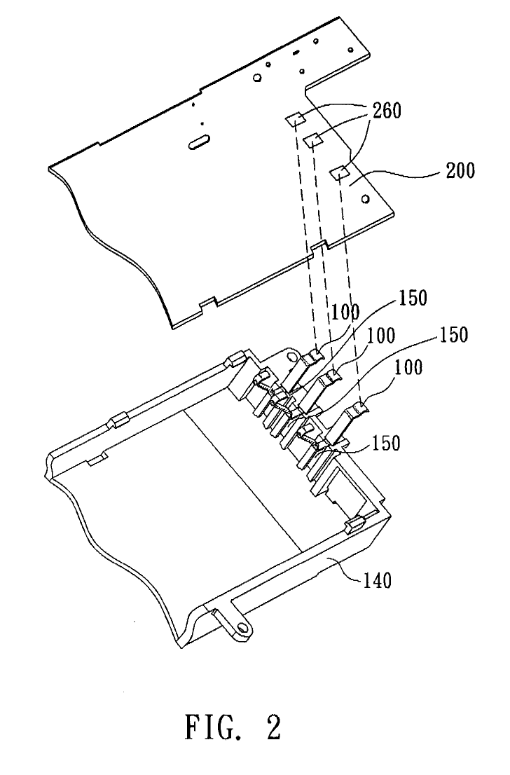

Referring to FIG. 3, a perspective diagram showing a battery spring fixed onto a battery housing in FIG. 2 after assembly is shown. In order to show the mechanism after assembly, the printed circuit board 200 is omitted in FIG. 3. Refer to both FIG. 1A, FIG. 1B and FIG. 2. after assembly, the elastic portion 110 with a narrower width projects from the slot 150 for electrically contacting one end of the battery (not shown here). The connection portion 120 is disposed in the slot 150 and is restricted by the groove 152. The flat portion 132 of the battery spring 100 is disposed on a first plane 154 of the slot 150 so that the flat portion 132 and the second plane 156 are co-planar after assembly and that the lumped arced portion 134 contacts the pad 260 of the printed circuit board 200.

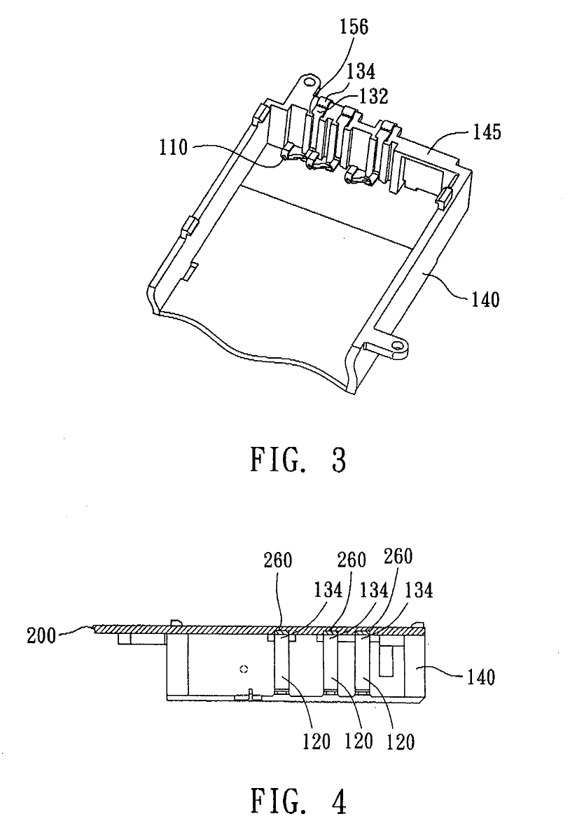

FIG. 4 is a sectional view of FIG. 2 after assembly. Refer to FIGS. 1˜3, after the battery spring 100 is fixed onto the battery housing 140 and the printed circuit board 200 is assembled with the battery housing 140, the connection portion 120 of the battery spring 100 is disposed in the slot 150, the lumped arced portion 134 is deformed when pressed downward by the printed circuit board 200 disposed above. Meanwhile, the arced portion 134 generates an opposite elastic restoring force and contacts the pad 260 of the printed circuit board 200 to assure that the battery spring 100 is electrically connected with the pad 260 disposed on the printed circuit board 200 firmly.

As disclosed above, the battery housing module and the assembling method thereof have a firm structure and can fix the battery spring firmly onto the battery housing without using any conventional methods of tin soldering, screwing or hot melting, and is free of tin breaking or the housing brokerage problems, saving the labor of tin soldering, screwing or hot melting and the cost related equipment. The invention is easy to assemble, save time and labor and largely reduces manufacturing costs.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A battery housing module for accommodating a battery comprising:
a housing having a sidewall, and the sidewall having a slot with a groove formed thereon; and
a battery spring, comprising:
a connection portion disposed within the slot, and the width of the connection portion being larger than the width of the groove, so the connection portion being restricted by the groove;
an elastic portion connected with the connection portion, and the width of the elastic portion being smaller than the width of the groove to allow the elastic portion pass through the groove and extend toward the battery; and
a contact portion connected with the connection portion and extending over an upper surface of the sidewall.

2. The battery housing module according to claim 1, wherein the contact portion of the battery spring comprises a flat portion and an arced portion, and the arced portion elastically contacts the printed circuit board.

3. The battery housing module according to claim 2, wherein the slot comprises an upper surface, the upper surface of the slot comprises a first plane and a second plane, and the first plane is lower than the second plane for accommodating the flat portion of the battery spring.

4. The battery housing module according to claim 2, wherein the printed circuit board has a corresponding pad disposed thereon for electrically contacting the arced portion of the battery spring.

5. The battery housing module according to claim 1, wherein the battery spring is made of a conductive and elastic material.

6. The battery housing module according to claim 1, wherein the sidewall of the housing has a plurality of slots to be correspondingly assembled with a plurality of battery springs.

7. An assembling method of a battery housing module, wherein the battery housing module comprises a housing and a battery spring, a sidewall of the housing has at least a slot with a groove formed thereon, the battery spring comprises an elastic portion, a connection portion and a contact portion, the two ends of the connection portion respectively connect the elastic portion and the contact portion, the width of the elastic portion is smaller than the width of the groove, and the width of the connection portion is larger than the width of the groove, the assembling method comprises the steps of:
passing the elastic portion of the battery spring through the groove of the slot;
having the connection portion and the slot be corresponding to each other and restricting the connection portion by the groove; and
sliding the connection portion in the slot until the contact portion contacts an upper surface of the slot.

8. The assembling method according to claim 7, wherein the printed circuit board directly presses the connection portion down until the battery spring reaches a predetermined position.

9. The assembling method according to claim 7, wherein the contact portion of the battery spring comprises a flat portion and an arced portion, and the arced portion elastically contacts the printed circuit board after assembly.

10. The assembling method according to claim 9, wherein the printed circuit board has a pad, so that the arced portion can elastically contact the corresponding pad after assembly.

11. The assembling method according to claim 9, wherein the upper surface of the slot comprises a first plane and a second plane, the first plane is lower than the second plane, and during assembling, the connection portion slides in the slot until the flat portion contacts the first plane of the slot.

12. The assembling method according to claim 7, wherein the elastic portion projects from the slot for electrically contacting one end of a battery accommodated in the housing.

13. The assembling method according to claim 7 applied in a digital still camera (DSC).

14. An electronic device, comprising:
a printed circuit board; and
a battery housing module for accommodating a battery, comprises:
a sidewall, wherein the sidewall has a slot with a groove and an rear-end aperture formed thereon, and the width of the slot is larger than the width of the groove; and
a battery spring, comprising:
a connection portion disposed within the slot, and the width of the connection portion being larger than the width of the groove, so the connection portion being restricted be the groove;
an elastic portion connected with the connection portion, and the width of the elastic portion being smaller than the width of the groove to allow the elastic portion pass through the groove and projects from the slot so that the elastic portion can contact a battery; and
a contact portion connected to the connection portion, the contact portion passing through the rear-end aperture and projecting from the slot to be fixed onto the printed circuit board.

15. The electronic device according to claim 14, wherein the contact portion comprises a flat portion and an arced portion, the arced portion elastically contacts the printed circuit board after assembly.

16. The electronic device according to claim 15, wherein the upper surface of the slot comprises a first plane and a second plane, and the first plane is lower than the second plane for accommodating the flat portion of the battery spring.

17. The electronic device according to claim 15, wherein the printed circuit board has a pad corresponding to and electrically contacting the arced portion of the battery spring.

18. The electronic device according to claim 14, wherein the sidewall has a plurality of slots to be correspondingly assembled with a plurality of battery springs.
